(19) United States
(12) Patent Application Publication
(10) Pub. No.: US 2007/0029871 A1
(43) Pub. Date: Feb. 8, 2007

(54) Independent articulating suspension for a multi-surface vehicle

(76) Inventors: William Allan Wake, Deer River, MN (US); Cary Safe, Grand Rapids, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/197,765

(22) Filed: Aug. 4, 2005

(51) Int. Cl. B60B 37/00; B60B 35/00

(52) U.S. Cl. 301/124.1

(57) ABSTRACT

A suspension for a tracked vehicle includes an undercarriage frame. The undercarriage frame includes an elongated rail having a first side and a second side, a first axle attached to the first side of the rail, and a second axle attached to the second side of the rail. The suspension also includes a first wheel set including at least one wheel rotatably attached to the first axle, and a second wheel set including at least one wheel rotatably attached to the second axle. The suspension further includes a track engaging the first wheel set and the second wheel set.

### FIELD OF THE INVENTION

The invention relates to a multi-surface vehicle, and more particularly to the suspension assembly associated with a multi-surface vehicle having an elastomeric track.

### BACKGROUND OF THE INVENTION

A variety of track driven vehicles have existed for many years. Tracked vehicles vary from 100 ton military tanks and bull-dozers to 300 pound snowmobiles. Track types vary from segmented steel tracks to one piece molded rubber tracks. The track is part of a undercarriage assembly which is attached to an undercarriage frame of the vehicle. The undercarriage assembly includes at least two tracks, one on each side of the vehicle. Several types of wheels interact with a track. A driving wheel or wheels drive the track which in turn drives the vehicle. A driving apparatus drives against lugs or protrusions on the insider of the track. Other of the wheels, sometimes referred to as bogie wheels, serve to guide the track and place the track in contact with the surface so that the track efficiently transfers power from the driving apparatus to the ground.

In the past, a set of bogie wheels have been attached to an undercarriage frame using a single axle. The single axle not only crossed the undercarriage frame but also traversed the track. As a result, each bogie wheel in the set of bogie wheels attached to the single axle move in the same way or in unison when, for example, an obstruction is encountered on the ground. In other words, all the bogie wheels traversing one of the tracks of the tracked vehicle move in unison or in the same way even when an obstruction is encountered on an outside edge of the track.

Generally the amount of power transferred to the ground by the tracks is much less than the power generated by the power source driving the driving apparatus. Power is lost in many ways. One of the ways power is lost is due to friction in the various mechanisms between the driving apparatus or mechanism and the track. Power is lost as generated heat. Another way power is lost is when the driven track loses contact with the ground or other surface over which the tracked vehicle passes. A constant goal is to transfer more power from the drive apparatus to the ground or surface over which the vehicle is traveling.

### BRIEF DESCRIPTION OF THE DRAWINGS

The following detailed description of the preferred embodiments can best be understood when read in conjunction with the following drawings, in which:

FIG. 1 is a side view of an example embodiment of the multi-surface vehicle.

FIG. 2A is perspective view of an example embodiment of a suspension associated with an undercarriage of the multi-surface vehicle.

FIG. 2B is side view of an example embodiment of a suspension associated with an undercarriage of the multi-surface vehicle.

FIG. 2C is an exploded perspective view of a big assembly.

FIG. 3A is a perspective view of an example embodiment of the track used with the multi-surface vehicle.

FIG. 3B is a cross-sectional view of the track used with a multi-surface vehicle.

FIG. 4 is a cross-sectional view showing the bogie wheels engaging the spaces between the drive lugs of the track.

FIG. 5 is a perspective view of a rail of the suspension of the undercarriage, according to an example embodiment.

FIG. 6 is a perspective view of a plurality of assembled bogie wheel assemblies rotatably attached to axles on a rail to form a bogie carriage assembly, according to an example embodiment.

FIG. 7A is a cross sectional cut away view of an idler wheel, according to an example embodiment.

FIG. 7B is a exploded perspective view of the idler wheel assembly hub and components, according to an example embodiment.

FIG. 8 is a perspective view of an idler wheel passing over a hub of the idler wheel assembly, according to an example embodiment.

### DETAILED DESCRIPTION

In the following detailed description, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

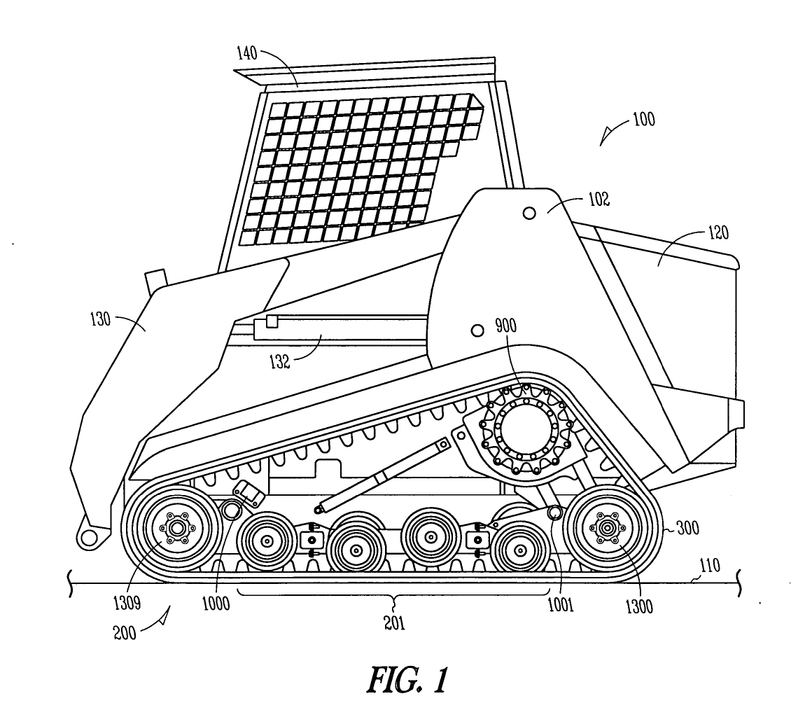

FIG. 1 shows a side view of an embodiment of the multi-surface vehicle 100 on a surface 110. The multi-surface vehicle 100 includes a body frame 102 which carries an engine 120. The engine 120 powers a hydrostatic transmission which powers hydraulic drive motors. As shown, the multi-surface vehicle 100 includes a loader accessory 130. The engine 120 powers hydraulic pumps used to drive the hydraulic cylinders 132 for operation of the loader 130. The vehicle 100 also includes an operator cab 140. The operator cab 140 is equipped with controls for controlling the loader accessory 130 and for operating the multi-surface vehicle 100. Attached to the body frame 102 of the multi-surface vehicle 100 is a tracked undercarriage assembly 200 that includes a suspension 201. A substantially duplicate suspension 201 is attached to the other side of the body frame 102. The undercarriage assembly 200 is attached to the body frame 102 via torsion mounts 1000 and 1001. The undercarriage 200 includes a drive sprocket assembly 900 for driving an elastomeric or rubber track 300. The undercarriage assembly 200 includes the suspension 201. The suspension 201 is the arrangement of various wheels and the mechanisms for suspending the wheels. The suspension 201 will be described more fully in the following paragraphs.

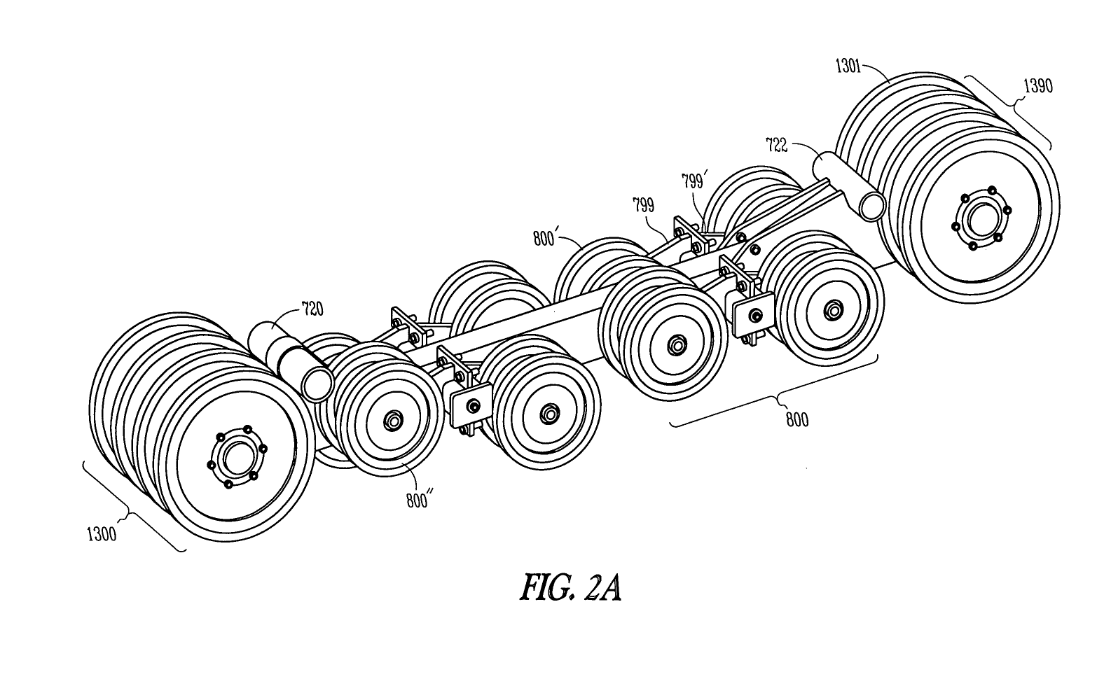

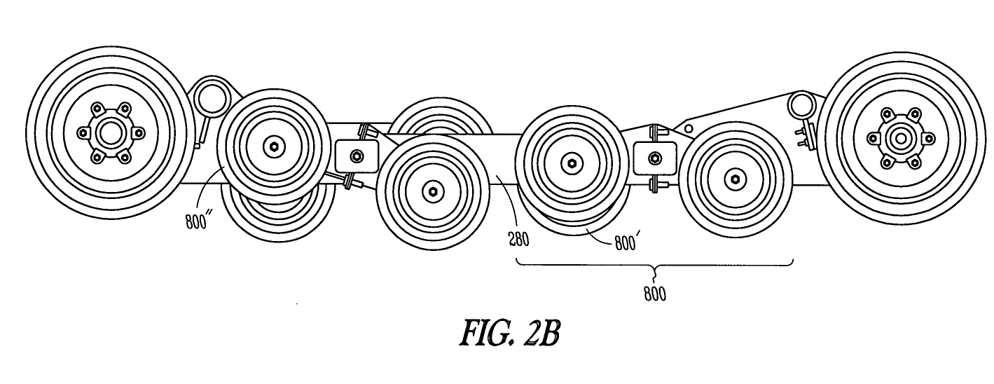

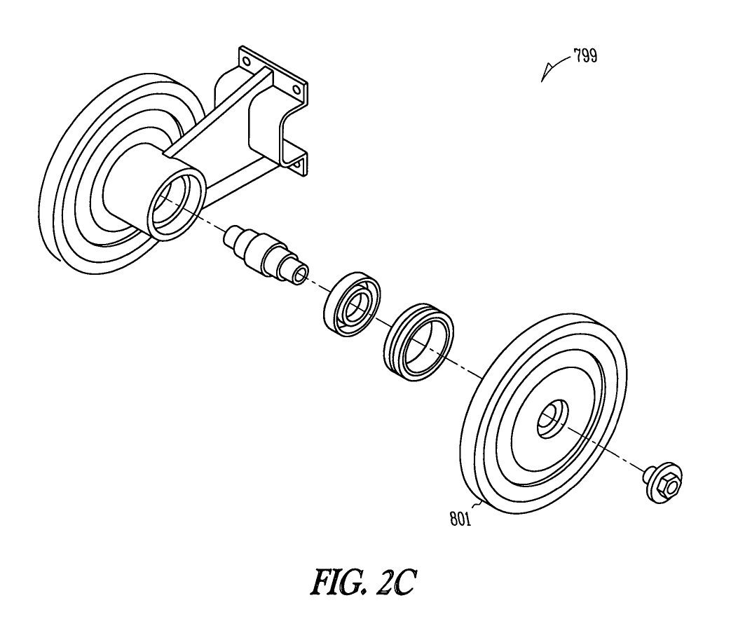

FIG. 2A is a perspective view of an example embodiment of the suspension 201 associated with the undercarriage assembly 200 of the multi-surface vehicle 100, and FIG. 2B is a side view of an example embodiment of a suspension 201 associated with an undercarriage assembly 200 of the multi-surface vehicle 100. FIG. 2C is an exploded perspective view of a bogie assembly 799. Referring now to FIGS. 1, 2A, 2B and 2C, the suspension 201 and the undercarriage assembly 200 will be further detailed. The suspension 201 includes bogie wheels 801 on bogie assemblies 799. Two bogie assemblies 799 make up a bogie carriage assembly 800. The suspension also includes idler wheels 1301 associated with idler wheel assemblies 1300.

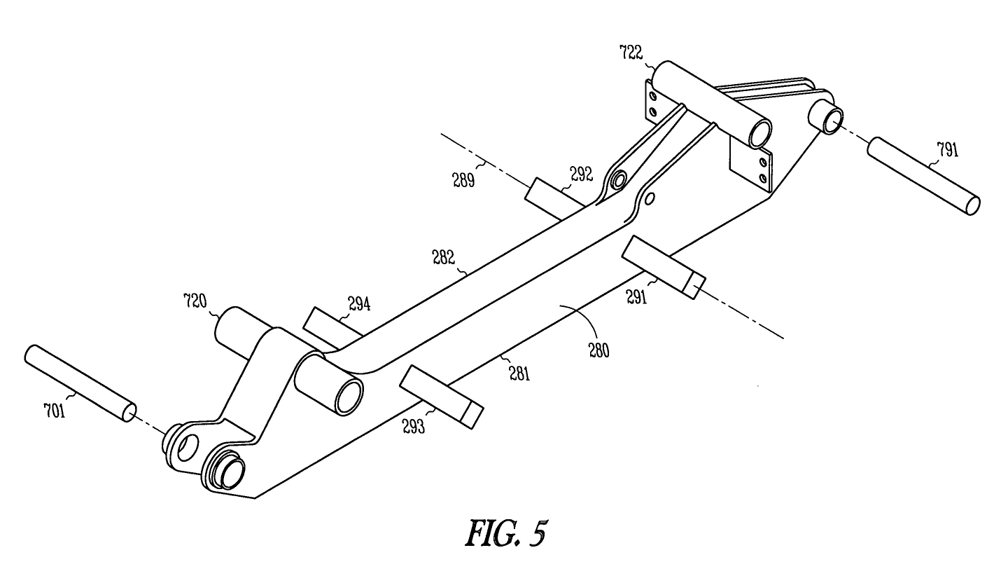

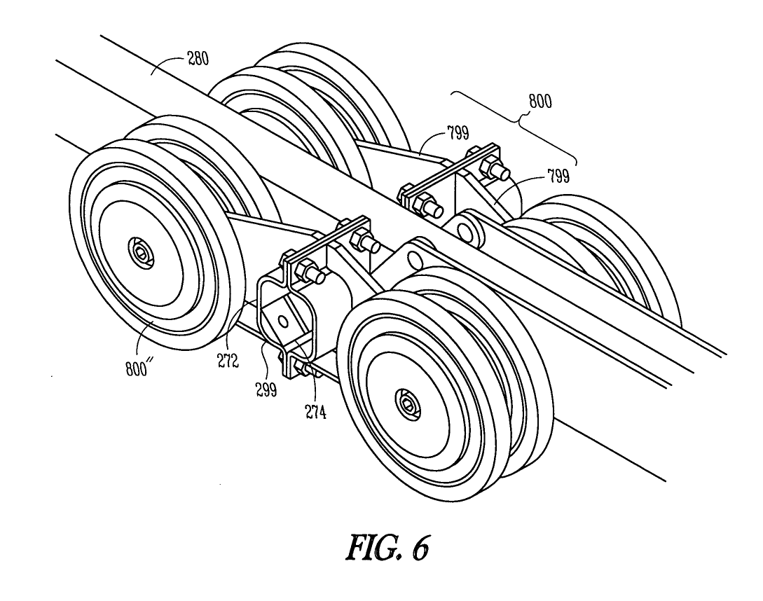

The suspension 201 for a tracked vehicle includes a rail 280. The elongated rail 280 (see FIG. 5 as well as FIGS. 2A and 2B) having a first side 281 and a second side 282. A first axle 291 is attached to the first side, 281, of the rail 280. A second axle 292 is attached to the second side, 282, of the rail 280. As shown in FIG. 5, the rail 280 can also include additional axles. Referring again to FIGS. 1, 2A, and 2B, the suspension 200 also includes a bogie carriage assembly 800 including at least one bogie wheel assembly 799 rotatably attached to the first axle 291, and a second bogie carriage assembly 800 including at least one bogie wheel assembly 799 rotatably attached to the second axle 292. As shown, each bogie carriage assembly includes a pair of bogie wheel assemblies. The suspension 201 further includes a track 300 engaging the bogie wheels, 801.

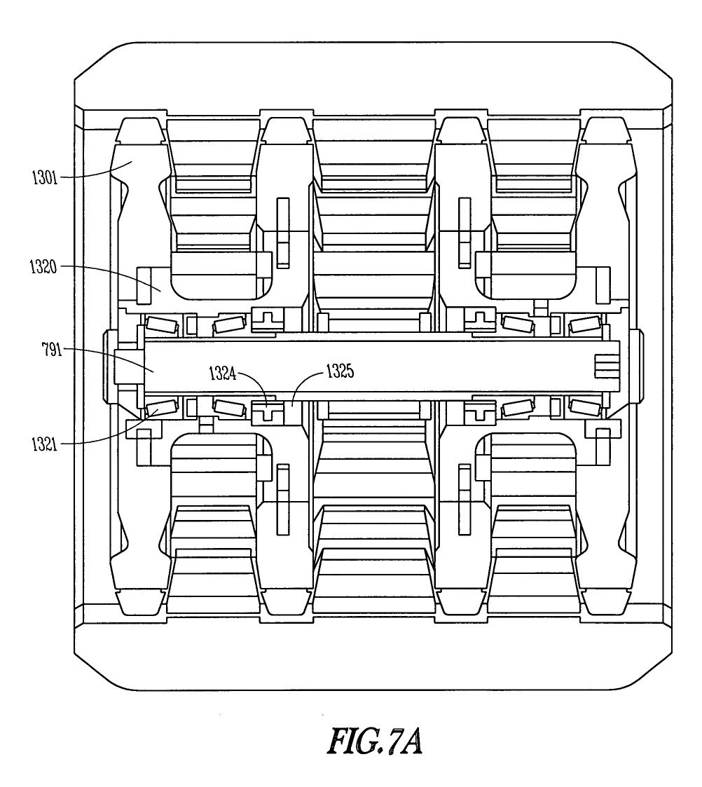

In some example embodiments, the first axle 291 and the second axle 292 of the rail 280 are substantially aligned. The first axle 291 and the second axle 292 are substantially collinear with a line 289 traversing the elongated rail 280. In some embodiments, the line 289 is substantially perpendicular to the elongated rail 280. The first axle 291 and the second axle 292 are each a bar having a substantially square cross section. Referring to FIG. 6, the bogie carriage assemblies 800 are attached to the first axle and the second axle, respectively, by a torsion mount 299. The torsion mount 299 further includes a outer square tube 272 surrounding the axle 292, and an elastomeric portion 274 that fits within the space between the axle 292 and the outer square tube 272. In one embodiment, the elastomeric portion 274 of the torsion mount 299 includes a set of elastomeric cords 274 placed between the axle, such as first axle 291 or second axle 292, and the element surrounding the axle, such as the outer square tube 272. In the particular embodiment shown, the square portion surrounding the axle is substantially square-shaped and having an inside dimension that is greater than the diagonal of the first axle 291 or the second axle 292. The elastomeric cord has a diameter that fits within the space between the outer square tube 272 and the axle 292. The torsion mount 299 allows limited rotation of the first bogie carriage assembly 800′ and the second bogie carriage assembly 800″ about the first axle 291 and the second axle 292, respectively. More specifically, the elastomeric portion 274 of the torsion mount 299 allows limited rotation between the first axle 291 and the outer square tube 272. The second axle 292 allows limited rotation of the bogie carriage assembly 800″ about the axle 292 on the opposite side of the rail 280. It should be noted that there is a torsion mount, such as torsion mount 299, associated with each of the axles and associated bogie carriage assemblies. Even though more than one axle and wheel set are shown, only one is described for the sake of simplicity. In other words, there is a first torsion mount between the first bogie carriage assembly 800′ and the first axle 291, and a second torsion mount between the second bogie carriage assembly 800″ and the second axle 292, and so on.

As mentioned previously, the outer square tube 272 is substantially square in cross section. In some example embodiments, the outer square tube 272 is formed by combining two bogie wheel assemblies 799. In another embodiment, the first bogie wheel assembly 799 and the second bogie wheel assembly 799′ are attached to a separate outer square tube 272.

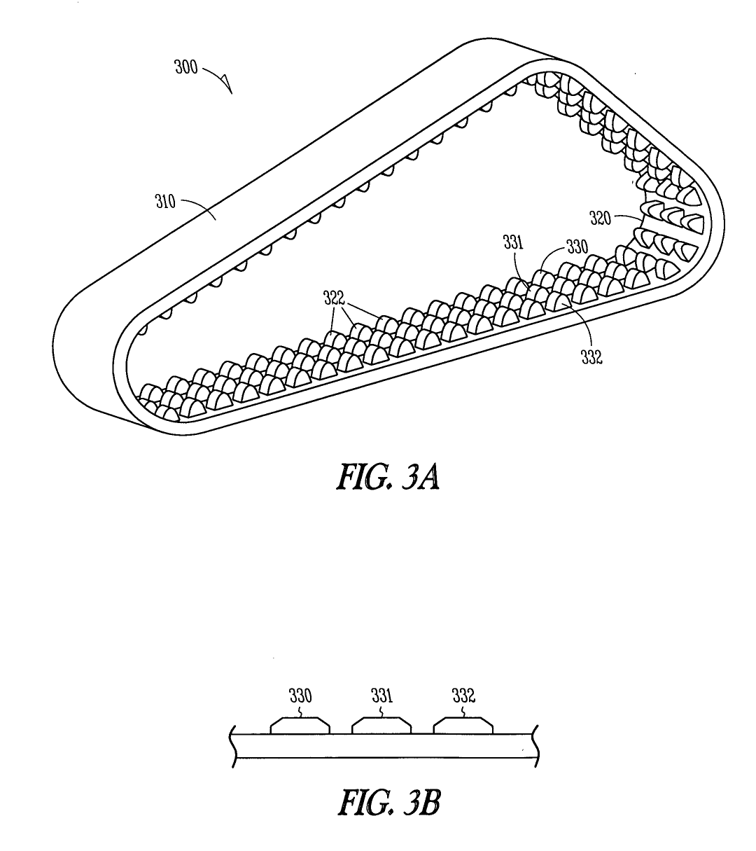

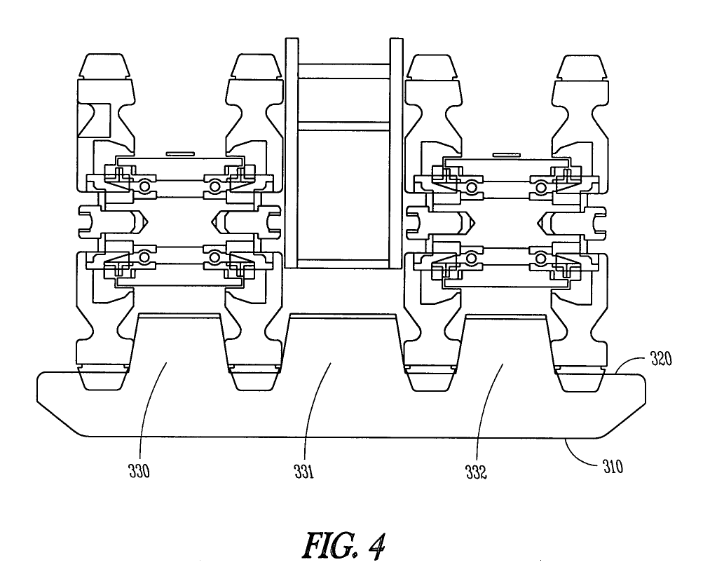

The elongated rail 280 has a first bogie carriage assembly 800′ rotatably attached to the first side 281 of the rail 280, and a second bogie carriage assembly 800″ rotatably attached to the second side 282 of the rail 280. The first bogie carriage assembly 800′ rotates independently of the second wheel assembly 800″. The track 300 contacts the first bogie carriage assembly 800′ and the second bogie carriage assembly 800″. The first bogie carriage assembly 800′ and the bogie carriage assembly 800″ are mounted to the elongated rail 280 substantially transverse from one another. The independent movement of the first bogie carriage 800′ with respect to the second bogie carriage assembly 800″ which is positioned across from the first bogie carriage assembly 800′ allows a greater portion of the track 300 to stay in contact with the ground or other surface over which the vehicle passes when an obstacle is engaged with less than half the width of the track 300. For example, if a stone or other obstacle engages less than half the track 300 or if only an edge of a larger boulder is passed over, the first bogie carriage assembly 800′ will track over the obstacle while the second bogie carriage assembly 800″ stays in contact with the ground. Thus, more of the power transferred to the track is in turn transferred to the ground which provides for more efficient operation of the vehicle 100. Other advantages include smoother operation for operator, less wear on the track 300, and added track life. FIG. 2B is side view of an example embodiment of the undercarriage assembly 200 associated with the suspension 201 of the multi-surface vehicle 100. As can be seen, the bogie carriage assembly 800″ moves independently of bogie carriage assembly 800′ when an obstacle is encountered on one side of the track 300 (track is shown in FIG. 1) The tracked vehicle 100 includes the suspension 201 and undercarriage assembly 200 as discussed above. The vehicle further includes a body frame 102 to which at least one suspension 201 is attached. The suspension 201 can include a set of undercarriage assemblies 200, each of which includes an elongated rail 280. The track 300 of the tracked vehicle 100 includes drive lugs 322 (see FIG. 3) attached to an inner surface of the track 300. A drive sprocket 900 attached to the undercarriage, 200, engages the drive lugs 322 and drives the track 300. The first bogie carriage assembly 800′ and the second bogie carriage assembly 800″ further include a number of bogie wheels, 801. Each of the bogie wheels creates a guiding surface between the drive lugs 322 of the track 300. The plurality of bogie wheels contact an inner surface of the track as the outer surface of the track engages the ground.

Also attached to the undercarriage assembly 200 at a position above and forward of the rear idler wheel assembly 1300 is drive sprocket assembly 900. The drive sprocket assembly 900 is in a fixed position with respect to the undercarriage assembly 200. It should be noted that the rear idler wheel assembly 1300, the forward idler wheel assembly 1390, and the drive sprocket 900 are all in fixed position with respect to the undercarriage 200. The idler wheel assembly 1300, the idler wheel assembly 1390, and the drive sprocket assembly 900 define the outer limits of the track 300. It is important to have a substantially fixed position for the idler wheel assembly 1300, the idler wheel assembly 1390, and the drive sprocket assembly 900 so that the track 300 is held in a substantially constant state of tension, even while the suspension is in motion. The pitch length of an elastomeric track 300, such as those made of rubber, will vary slightly.

FIG. 3A is a perspective view of an example embodiment of the track 300 used with the multi-surface vehicle 100. FIG. 3B is a cross-sectional view of the track 300 used with a multi-surface vehicle 100. The track 300 has an inner surface 320. Attached or molded to the inner surface 320 of the track 300 are a plurality of drive lugs 322. The drive lugs 322 are arranged in three rows 330, 331 and 332. The spacing between the rows 330, 331 and 332 is selected so that the width of the bogie wheels, 801, fit between the spaces of the drive lugs 330, 331, and 332. Typically, clearance is provided so that the track 300 can shift an appropriate amount during a turn or other operation, and so the wheels do not create a binding effect on the track. The spacing from one lug 322 to another within a row is selected so that the lugs 322 will properly engage the drive sprocket assembly 900. Proper engagement would match the pitch diameter of the drive sprocket assembly 900 to the pitch line of the track 300. Of course, this is difficult to achieve since there are different forces on the track 300 at various times. FIG. 3 is an embodiment of the track 300 having an outer surface 310.

FIG. 4 is a cross-sectional of the track undercarriage assembly. Wheels contacting the inner surface 320 of the track 300 have been added in phantom to FIG. 6. The wheels could be either the bogie wheels 801 or the idler wheels 1301. The rows 330, 331 and 332 of lugs 322 are spaced such that the wheels 801, 1301, of the undercarriage assembly 200 fit between the rows 330, 331 and 332, and between the rows 330, 331 and 332 and the outer edges of the track 300. The lugs 322 limit the side-to-side motion of the track 300 and prevent the track 300 from dislodging or jumping off the track. The wheels, do not fit tightly with respect to the rows 330, 331 and 332 of lugs 322. This allows for slight movement of the track 300 with respect to the wheels. Another aspect of these driving lugs 322 is that the spacing between the lugs 322 allows some lateral movement in the track 300. The lateral movement enhances the turnability of the vehicle 100.

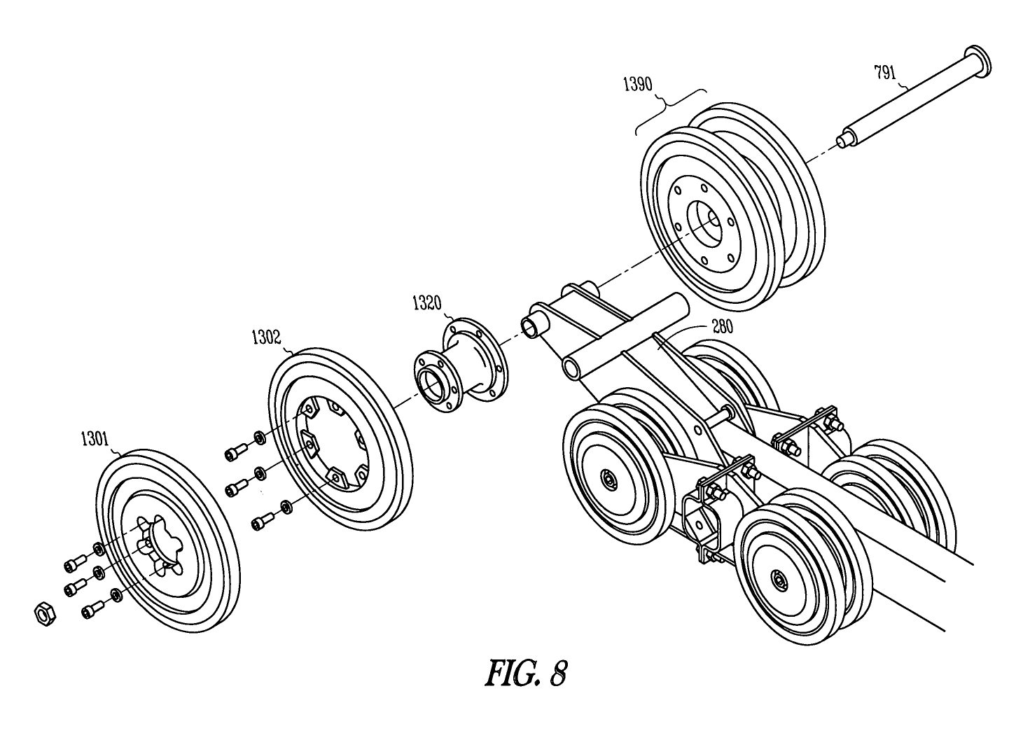

FIG. 5 is a perspective view of a rail 280 of the suspension 201 of the undercarriage assembly 200, according to an example embodiment. The rail 280 is elongated and includes the first side 281 and the second side 282. The rail has several square axles. Square axle 291 and a square axle 293 are attached to the first side 281 of the rail 280. Square axle 292 and a square axle 294 are attached to the second side 282 of the rail 280. The square axles 291, 292, 293 and 294 carry the bogey carriage assemblies 800, 800′, 800″ (shown in FIGS. 2A and 2B). The bogey carriage assemblies 800, 800′, 800″ are attached to the square axles 291, 291, 293, 294 byway of the torsion mounts, such as torsion mount 299 shown in FIG. 6. Referring to FIG. 5 and FIG. 8, the rail 280 also includes an axle 791 and an axle 701. The axle 791 and 701 carry idler wheel assemblies 1390 and 1300, respectively. The axles 701 and 791 are positioned near or at the ends of the rail 280. The axles 701 and 791 are also round axles since the idler wheels 1301 and 1391 will turn or completely rotate around a hub which is attached to one of the axles 701 or 791. The rail 280 also includes a first attachment element 720 and a second attachment element 722. The attachment elements 720, 722 are used to attach the rail 280 to the frame of the main body 102 of the multi-track vehicle 100.

FIG. 6 is a perspective view of a plurality of assembled bogey carriage assemblies 800, 800′ rotatably attached to axles on the rail 280, according to an example embodiment. As shown, bogey wheel assemblies 799 carrying a set of bogey wheels 801 is attached to, or forms, a square outer tube 272 of a torsion mount 299. The bogie wheel assemblies, 799, are bolted together to create a bogie carriage assembly, 800. Similar bogie wheel assemblies are placed on the other axles, such as axles 291, 292, 293, 294 of the rail 280 to form an undercarriage suspension, such as the one shown in FIGS. 2A and 2B.

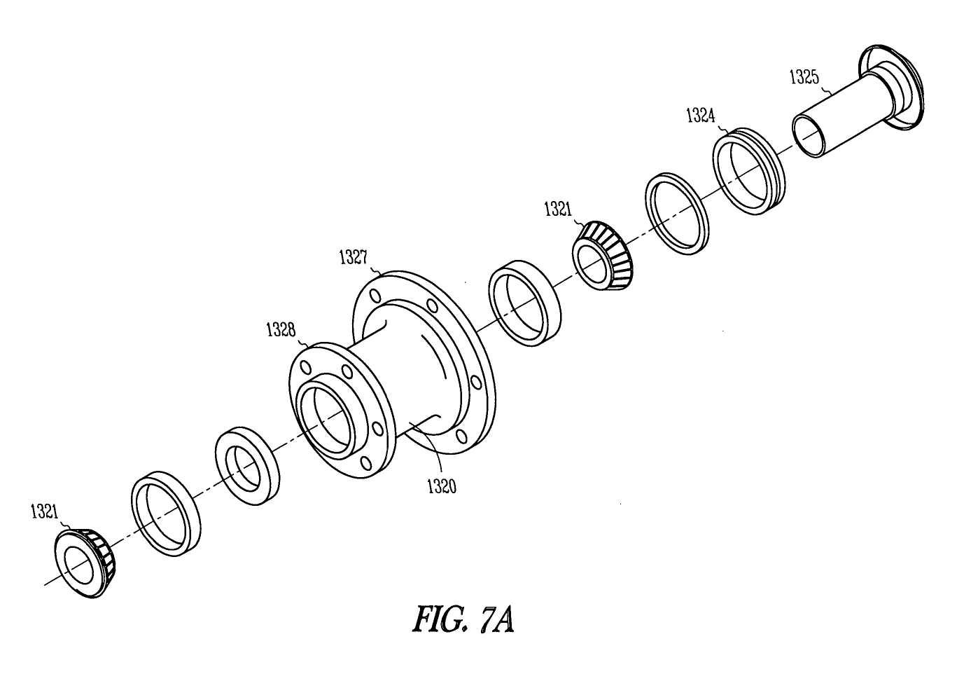

FIG. 7A is a cross sectional cut away view of an idler wheel assembly 1300, and 1390, according to an example embodiment. The idler wheel assembly 1300, 1390 for a tracked vehicle 100 includes, the wheels, 1301, a hub, 1320, bearings, 1321, a seal, 1324, a seal holder, 1325, and a axle 791.

FIG. 7B is an exploded perspective view of the idler wheel hub, 1320, and related components.

FIG. 8 is a perspective view of an idler wheel passing over a hub 1320, according to an example embodiment. The inner idler wheel 1302 is attached to the large diameter, 1327, of hub 1320. The outside idler wheel, 1301, is attached to the smaller diameter, 1328, of the hub, 1320. In this manner the idler wheels can be removed for service, without removing the hub, 1320, from the rail, 280.

What is claimed is:

1. A suspension for a tracked vehicle comprising:
an undercarriage assembly further comprising:
an elongated rail having a first side and a second side;
a first axle portion attached to the first side of the rail; and
a second axle portion attached to the second side of the rail;
a first bogie wheel assembly including at least one wheel rotatably attached to the first axle;
a second bogie wheel assembly including at least one wheel rotatably attached to the second axle; and
a track engaging the first bogie wheel assembly and the second bogie wheel assembly.

2. The suspension of claim 1 wherein the first axle portion and the second axle portion are substantially aligned.

3. The suspension of claim 1 wherein the first axle portion and the second axle portion are substantially collinear with a line traversing the elongated rail.

4. The suspension of claim 1 wherein the first axle portion and the second axle portion include a bar having a substantially square cross section.

5. The suspension of claim 1 wherein at least one of the first bogie wheel assembly and the second bogie wheel assembly are attached to at least one of the first axle and the second axle by a torsion mount allowing limited rotation of the at least one of the first bogie wheel assembly and the second bogie wheel assembly about the first axle and the second axle.

6. The suspension of claim 1 further comprising:
a first torsion mount between the first bogie wheel assembly and the first axle; and
a second torsion mount between the second bogie wheel assembly and the second axle.

7. The suspension of claim 6 wherein the first axle portion and the second axle portion include bars having a substantially square cross section, wherein each of the first torsion mount and the second torsion mount further comprises:
an outer tube surrounding one of the first axle portion or the second axle portion; and
an elastomeric portion fitting within the space between one of the first axle portion or the second axle portion and the outer tube, the elastomeric portion of the torsion mount allowing limited rotation between the one of the first axle portion or the second axle portion and the outer tube.

8. The suspension of claim 7 wherein the outer square tube is substantially square in cross section.

9. The suspension of claim 7 wherein the outer square tube is formed from a first portion of one of the first bogie wheel assembly or the second bogie wheel assembly, and from a second portion of one of the first bogie wheel assembly or the second bogie wheel assembly.

10. The suspension of claim 7 wherein each of the first bogie wheel assembly and the second bogie wheel assembly further comprise:
a first portion, and
a second portion, the first portion and the second portion attached to the outer tube.

11. The suspension of claim 7 wherein the elastomeric portion includes an elastomeric cord having a diameter that fits within the space between the outer tube and the axle.

12. The suspension of claim 1 further comprising a suspension mount for mounting the suspension to a vehicle.

13. A suspension for a tracked vehicle comprising:
an undercarriage assembly further comprising an elongated rail having a first side and a second side;
a first bogie carriage assembly rotatably attached to the first side of the rail;
a second bogie carriage assembly rotatably attached to the second side of the rail, the first bogie carriage assembly rotating independently of the second bogie carriage assembly; and
a track engaging the first bogie carriage assembly and the second bogie carriage assembly.

14. The suspension of claim 13 wherein the first bogie carriage assembly and the second bogie carriage assembly are mounted to the elongated rail substantially transverse from one another.

15. The suspension of claim 13 further comprising:
a first axle attached to the first side of the rail, the first bogie carriage assembly rotatably attached to the first axle; and
a second axle attached to the second side of the rail, the second bogie carriage assembly rotatably attached to the second axle.

16. The suspension of claim 15 further comprising:
a first torsion mount for rotatably attaching the first bogie carriage assembly to the first axle; and
a second torsion mount for rotatably attaching the second bogie carriage assembly to the second axle.

17. The suspension of claim 13 wherein each of the first bogie carriage assembly and the second bogie carriage assembly further comprise:
a first portion, and
a second portion.

18. The suspension of claim 17 wherein the first portion and the second portion of at least one of the first bogie carriage assembly and the second bogie carriage assembly comprise a portion of at least one of the first torsion mount or the second torsion mount.

19. A tracked vehicle including the suspension of claim 13, the vehicle further comprising a body frame to which at least one suspension is attached.

20. The tracked vehicle of claim 19 further comprising:
drive lugs attached to an inner surface of the track;
a drive mechanism attached to the body frame;
a drive sprocket attached to the drive mechanism that engage the drive lugs and drive the track.

21. The tracked vehicle of claim 20 wherein the first bogie carriage assembly and the second bogie carriage assembly further comprise a plurality of spaced wheels, a portion of the spaced wheels mounted to engage the track between the drive lugs.

22. The tracked vehicle of claim 20 wherein the first bogie carriage assembly and the second bogie carriage assembly further comprise a plurality of spaced wheels, the plurality of wheels contacting an inner surface of the track as the outer surface of the track engages the ground, said plurality of wheels closely spaced such that the flexing of the track is minimized between each of the wheels as the vehicle traverses the ground.

23. A rail for a suspension assembly comprising:
a first square axle attached to the first side of the rail; and
a second square axle attached to the second side of the rail.

24. The rail of claim 23 wherein the first square axle and the second square axle are substantially collinear with a line transverse to the rail.

25. The rail of claim 24 wherein the line transverse to the rail is substantially orthogonal to the rail.
